(19) United States
(12) Patent Application Publication
(10) Pub. No.: US 2023/0062437 A1
(43) Pub. Date: Mar. 2, 2023

(54) RELIEF VALVE

(71) Applicant: NISHINA INDUSTRIAL CO., LTD., Nagano-shi (JP)

(72) Inventors: Shogo Koyama, Nagano-shi (JP); Gaku Mabuchi, Nagano-shi (JP); Shigeto Nakajima, Nagano-shi (JP)

(73) Assignee: NISHINA INDUSTRIAL CO., LTD., Nagano-shi (JP)

(21) Appl. No.: 17/894,321

(22) Filed: Aug. 24, 2022

(30) Foreign Application Priority Data
Aug. 26, 2021 (JP) 2021-138240

(51) Int. Cl. F16K 17/06; F16K 17/04

(52) U.S. Cl. CPC F16K 17/06; F16K 17/0486

(57) ABSTRACT

There is provided a relief valve capable of realizing miniaturization, weight reduction, and simplification of structure, and preventing vibration during operation. A relief valve for releasing a pressure by causing a valve body to separate from a valve seat when a pressure exceeding a set value is applied to the valve body, including an urging member that applies an urging force to the valve body to press-contact the valve body with the valve seat, the urging member being locked to a force receiving section fixedly formed in a middle portion in the axial direction of the valve body either integrally with or separately from the valve body and directly applies the urging force to the force receiving section.

### CROSS-REFERENCE TO RELATED APPLICATION

This application is based upon and claims the benefit of priority of the prior Japanese Patent Application No. P2021-138240, filed on Aug. 26, 2021, and the entire contents of which are incorporated herein by reference.

### TECHNICAL FIELD

The present invention relates to a relief valve.

### BACKGROUND ART

A working vehicle such as a forklift or a construction machine is configured with a work device such as a fork or a bucket driven by a pressure fluid (hereinafter, often, simply referred to as “fluid”). A circuit that drives such a work device is provided with a relief valve that controls a fluid pressure as appropriate.

As an example of the relief valve, there is known a solenoid proportional relief valve that can regulate a set release pressure (i.e., relief pressure) by changing a thrust of a proportional solenoid (refer to PTL: JP-A-6-323451).

### SUMMARY OF INVENTION

### Technical Problem

The solenoid proportional relief valve disclosed in PTL 1 can reduce pilot pipes and pressure switching components, compared with a conventional pilot selector relief valve and can, therefore, facilitate miniaturization, weight reduction, and simplification of structure and also reduce a manufacturing cost. The solenoid proportional relief valve has, however, a conventional problem of tending to vibrate (chatter) during operation.

### Solution to Problem

The present invention has been accomplished under the circumstances, and an object of the present invention is to provide a relief valve capable of realizing miniaturization, weight reduction, and simplification of structure and preventing vibration during operation.

According to an aspect, the problems described above are solved by the following disclosed solution.

A disclosed relief valve for releasing a pressure by causing a valve body to separate from a valve seat when a pressure exceeding a set value is applied to the valve body, includes an urging member that applies an urging force to the valve body to press-contact the valve body with the valve seat, wherein the urging member is locked to a force receiving section fixedly formed in a middle portion in the axial direction of the valve body either integrally with or separately from the valve body and directly applies the urging force to the force receiving section.

Furthermore, the relief valve further includes a proportional solenoid driving section having a fixed iron core and a needle, wherein the needle is locked to the force receiving section, and applies a force in an opposite direction to the urging force to the force receiving section when the fixed iron core is excited.

Moreover, in the relief valve, the needle is formed into a cylindrical shape with a bottom portion provided with an insertion hole at a center, and has entirety of or part of the urging member and the force receiving section provided therein.

Furthermore, in the relief valve, the urging member is a coil spring, and the force receiving section is an annular member.

Moreover, in the relief valve, the force receiving section has a flow path that communicates a first surface to which the urging member is locked with a second surface opposite to the first surface.

Furthermore, in the relief valve, a member abutting on the valve body is not provided at a position between the needle closer to the valve seat than the force receiving section and the valve seat.

Moreover, the relief valve further includes a guide member slidably supporting the valve body in an axially movable manner at a position between the needle closer to the valve seat than the force receiving section and the valve seat.

Furthermore, in the relief valve, the fixed iron core has a base provided at a farther position from the valve body, and a stator provided at a closer position to the valve body, and the stator is formed into a shape that extends to a region opposed to the valve body and a shape integral with a body provided with a first flow path in which a fluid applying a pressure to the valve body flows, and has the valve seat provided therein.

### Advantageous Effects of Invention

According to the disclosed relief valve, it is possible to prevent vibration during operation and ensure stable fluid control, i.e., accurate relief pressure regulation. It is also possible to realize miniaturization, weight reduction, and simplification of structure.

### BRIEF DESCRIPTION OF DRAWINGS

FIG. 1 is a circuit diagram illustrating an example of configurations of a circuit into which a relief valve according to an embodiment of the present invention is incorporated.

FIG. 2 is a front cross-sectional view illustrating an example of the relief valve according to the embodiment of the present invention.

FIG. 3 is an enlarged view of part III in FIG. 2.

FIGS. 4A and 4B are schematic diagrams illustrating an example of a force receiving section of the relief valve according to the embodiment of the present invention, where FIG. 4A is a side view and FIG. 4B is a front cross-sectional view.

FIGS. 5A and 5B are schematic diagrams illustrating another example of the force receiving section of the relief valve according to the embodiment of the present invention, where FIG. 5A is a side view and FIG. 5B is a front cross-sectional view.

FIGS. 6A and 6B are schematic diagrams illustrating another example of the force receiving section of the relief valve according to the embodiment of the present invention, where FIG. 6A is a side view and FIG. 6B is a front cross-sectional view.

### DESCRIPTION OF EMBODIMENTS

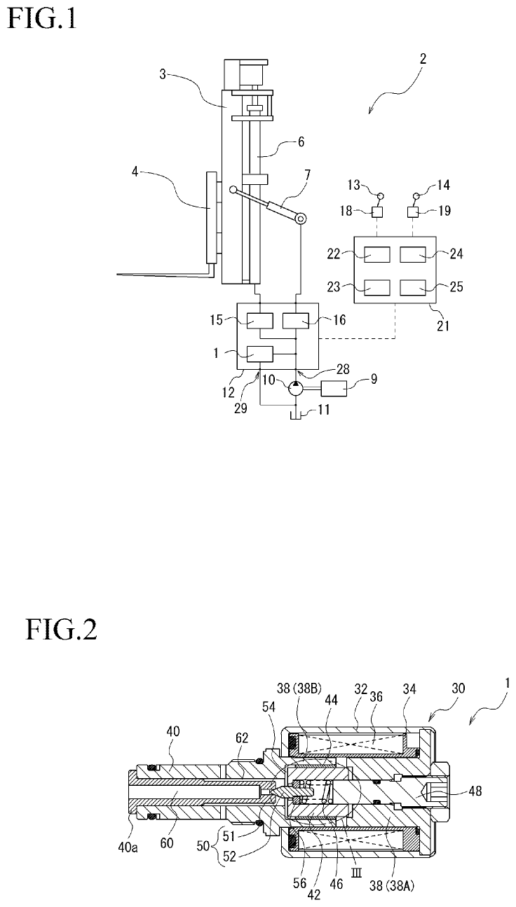

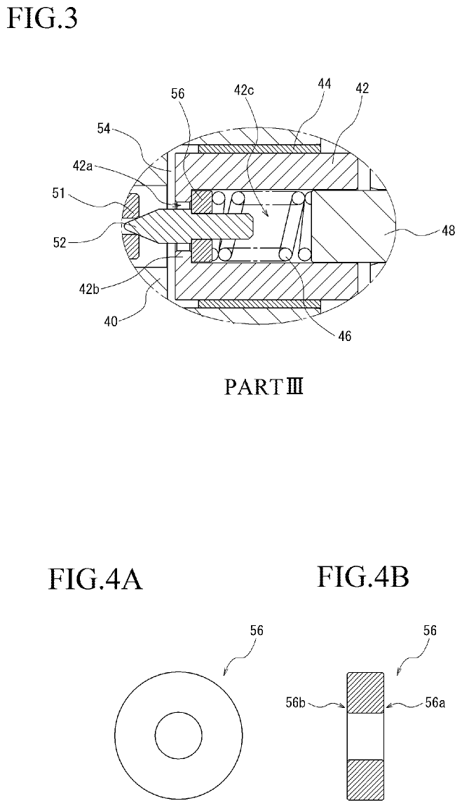

An embodiment of the present invention will be described hereinafter in detail with reference to the drawings. FIG. 1 is a circuit diagram (schematic diagram) illustrating an example of configurations of a circuit into which a relief valve according to an embodiment of the present invention is incorporated. FIG. 2 is a front cross-sectional view (schematic diagram) of the relief valve according to the embodiment of the present invention. FIG. 3 is an enlarged view of part III in FIG. 2. It is noted that members having the same function are denoted by the same reference sign and not repeatedly described in all the drawings for describing the embodiment.

A relief valve 1 according to the present embodiment is incorporated into a circuit (specifically, a hydraulic circuit), for example, for a pressurized fluid (specifically, a hydraulic operating fluid at a predetermined pressure) driving a work device in a working vehicle 2, and functions to control a fluid, i.e., to set and regulate a relief pressure. A “forklift” will be described hereinafter as an example of the working vehicle 2. However, an example of the circuit into which the relief valve 1 is incorporated is not limited to this circuit.

The working vehicle (forklift in this example) 2 with circuit configurations illustrated in FIG. 1 includes a mast 3 and a fork 4 as a work device driven by the fluid. Furthermore, the working vehicle (forklift) 2 includes a drive source (engine or motor) 9 driving travel devices and the work devices, a hydraulic pump 10 that is driven by this drive source 9 and that delivers a fluid (working fluid), a tank 11 that stores the fluid, a control valve 12 provided between the hydraulic pump 10 and the work device, a lift operation lever 13 that operates the fork 4, and a tilt operation lever 14 that operates the mast 3. The working vehicle (forklift) 2 also includes a lift operation detecting sensor 18, a tilt operation detecting sensor 19, and a controller 21.

The working vehicle 2 is provided herein with a lift cylinder 6 that vertically moves the fork 4 and a tilt cylinder 7 that tilts the mast 3. As specific operation, the fork 4 rises when the lift cylinder 6 is extended and the fork 4 lowers when the lift cylinder 6 is shrunk. In addition, the mast 3 tilts forward when the tilt cylinder 7 is extended and the mast 3 tilts rearward when the tilt cylinder 7 is shrunk.

Furthermore, the control valve 12 has a lift solenoid proportional control valve 15, a tilt solenoid proportional control valve 16, and the relief valve 1.

Here, the lift solenoid proportional control valve 15 is provided between the hydraulic pump 10 and the lift cylinder 6. The lift solenoid proportional control valve 15 controls a flow rate of a hydraulic operating fluid supplied from the hydraulic pump 10 to the lift cylinder 6 by a change in an opening degree of the lift solenoid proportional control valve 15 in proportion to a control current value input to a solenoid section.

Furthermore, the tilt solenoid proportional control valve 16 is provided between the hydraulic pump 10 and the tilt cylinder 7. The tilt solenoid proportional control valve 16 controls a flow rate of a hydraulic operating fluid supplied from the hydraulic pump 10 to the tilt cylinder 7 by a change in an opening degree of the tilt solenoid proportional control valve 16 in proportion to a control current value input to a solenoid section.

On the other hand, the relief valve 1 is a solenoid proportional relief valve that opens when a pressure between the hydraulic pump 10 and the tilt cylinder 6, 7 reaches a relief pressure (detailed configurations of the relief valve 1 will be described later). When the relief valve 1 opens, a fluid supplied from a main port 28 is delivered to a tank port 29 to release a pressure. The relief pressure of the relief valve 1 changes in proportion to a control current value input to a solenoid section (proportional solenoid driving section 30 to be described later).

Next, the lift operation detecting sensor 18 detects an operation state (an operation direction and an operation amount) of the lift operation lever 13. The tilt operation detecting sensor 19 detects an operation state (an operation direction and an operation amount) of the tilt operation lever 14.

Moreover, a lift control valve control section 22 controls the lift solenoid proportional control valve 15 in response to the operation state of the lift operation lever 13 detected by the lift operation detecting sensor 18. Specifically, the lift control valve control section 22 outputs the control current value corresponding to the operation amount of the lift operation lever 13 to the solenoid section of the lift solenoid proportional control valve 15.

Furthermore, a tilt control valve control section 23 controls the tilt solenoid proportional control valve 16 in response to the operation state of the tilt operation lever 14 detected by the tilt operation detecting sensor 19. Specifically, the tilt control valve control section 23 outputs the control current value corresponding to the operation amount of the tilt operation lever 14 to the solenoid section of the tilt solenoid proportional control valve 16.

Moreover, a relief pressure setting section 24 sets the relief pressure of the relief valve 1 on the basis of, for example, a lift operation (lift pressure), a tilt operation (tilt pressure), a drive source (engine) revolving speed, and the like. Furthermore, a relief pressure control section 25 controls the relief valve 1 in response to the relief pressure set by the relief pressure setting section 24. Specifically, the relief pressure control section 25 outputs the control current value corresponding to the set relief pressure to the solenoid section (proportional solenoid driving section 30 to be described later) of the relief valve 1.

With such configurations, the relief valve 1 opens when the pressure between the hydraulic pump 10 and the lift cylinder 6 and that between the hydraulic pump 10 and the tilt cylinder 7 reach the set relief pressure. At this time, the hydraulic operating fluid from the hydraulic pump 10 is discharged to the tank 11 through the relief valve 1.

As described above, the relief valve with the proportional solenoid has the problem of tending to vibrate during operation. To address the problem, the inventors of the present application diligently conducted a study and determined that one of causes of occurrence of the “vibration” as the problem is that a direction of action in which a needle of the proportional solenoid drive section applies a thrust to a valve body is deviated (tilted) from an axis line at an extremely small angle.

Therefore, the relief valve 1 according to the present embodiment is capable of solving the problem by including the following configurations.

First, overall configurations of the relief valve 1 according to the present embodiment will be described. The relief valve 1 functions to protect a hydraulic circuit by delivering the hydraulic operating fluid within a target flow path (hereinafter, referred to as “main flow path”) in the hydraulic circuit when a pressure in the main flow path becomes equal to or higher than the relief pressure.

As illustrated in FIG. 2, the relief valve 1 includes a body 40 and the proportional solenoid driving section 30 provided in an end portion of the body 40. First, a first flow path 60 communicating with the main port 28 that is a primary side and a second flow path 62 communicating with the tank port 29 that is a secondary side are formed in the body 40. In a communication chamber 54 that communicates the first flow path 60 with the second flow path 62, a valve seat 51 and a valve body 52 that serve as an opening/closing section 50 that changes over a state of the first flow path 60 and the second flow path 62 between a communication state and a non-communication state (i.e., opens or closes between the first flow path 60 and the second flow path 62) are provided. In the present embodiment, the first flow path 60 and the valve seat 51 are provided in a flow path member 40a press-fitted into the body 40.

Next, the proportional solenoid driving section 30 includes, within a case 32 fixed to the end portion of the body 40, a coil 36 wound around a bobbin 34 while insulating a long conductor member, a fixed iron core 38 that passes through magnetic flux lines generated by excitation of the coil 36, and a needle 42 that passes through the magnetic flux lines generated by the excitation of the coil 36 and that moves along an axial direction of the coil 36 (i.e., a direction along a central axis of the coil 36 wound around the bobbin 34, the same applies hereinafter) by a suction force generated due to the magnetic flux lines.

The case 32 is a cylindrical member (that may be prismatic instead of being cylindrical) that accommodates the coil 36, the fixed iron core 38, the needle 42, and the like, and is formed from, for example, a soft magnetic material such as carbon steel or free-cutting steel.

The coil 36 is configured such that a long insulating-coated conductor member is wound around the bobbin 34. While the conductor member is, for example, a wire rod formed to have a cross-section of a circular shape, a square shape, or the like using a copper alloy or the like, the conductor member may be a tape material, a sheet material, or the like (not illustrated).

The fixed iron core 38 is a member that suctions the needle 42 through the magnetic flux lines generated by the excitation of the coil 36, and is formed from, for example, a soft magnetic material such as carbon steel or free-cutting steel. In the present embodiment, a base 38A and a stator 38B that are disposed to be apart from each other are provided as the fixed iron core 38. The base 38A is provided at a distant position from the valve body 52 while the stator 38B is provided at a close position to the valve body 52.

The needle 42 is a member through which the magnetic flux lines generated when the coil 36 is excited pass and which moves along the axial direction of the coil 36 by the suction force generated due to the magnetic flux lines and traveling to the fixed iron core 38. In the present embodiment, the needle 42 is supported in the communication chamber 54 of the body 40 to be axially movable via a bush 44. For example, the needle 42 is formed from a soft magnetic material such as carbon steel or free-cutting steel. In addition, the bush 44 is formed from a non-magnetic material (such as a stainless alloy or a resin material).

In the proportional solenoid driving section 30 described above, exciting the coil 36 generates a force for the fixed iron core 38 to attract the needle 42, and generates an action to thrust the needle 42 in a predetermined direction (a direction from the stator 38B to the base 38A in this case) (i.e., action to diminish an urging force of an urging member 46 to be described later). Furthermore, degaussing the coil 36 dissipates the force for the fixed iron core 38 to attract the needle 42, thus returning the proportional solenoid driving section 30 to a state in which the urging force of the urging member 46 is not diminished but applied to the valve body 52. Since the configurations of the proportional solenoid driving section 30 according to the present embodiment are those of the so-called proportional solenoid, it is possible to change the force by which the fixed iron core 38 attracts the needle 42 (i.e., a thrust of the needle 42) by changing an exciting current value of the coil 36. Specifically, the thrust is increased by increasing the exciting current value and reduced by reducing the exciting current value.

Here, characteristic configurations of the relief valve 1 according to the present embodiment are as follows. The needle 42 is formed into a cylindrical shape having a bottom portion 42b provided with an insertion hole 42a through which the valve body 52 is movably inserted at a center of the bottom portion 42b and having an internal space portion configured as a spring chamber 42c. That is, the urging member (e.g., coil spring) 46 described above is accommodated in the spring chamber 42c. These configurations enable miniaturization of the relief valve 1 in both radial dimensions and axial dimensions. While the relief valve 1 according to the present embodiment is configured so that entirety of the urging member 46 is accommodated in the spring chamber 42c, the relief valve 1 may be configured so that part of the urging member 46 is accommodated in the spring chamber 42c (not illustrated).

The urging member 46 described above acts to urge the valve body 52 in the axial direction, i.e., direction of the valve seat 51 along a central axis of the valve body 52 using an elastic force (urging force), and to press the valve body 52 against the valve seat 51 to contact the valve body 52 with the valve seat 51. Therefore, an initial set value of the relief pressure is set by the urging force of the urging member 46 and regulated by a revolution of a pressure regulation screw 48. In the present embodiment, the pressure regulation screw 48 is rotatably supported in the fixed iron core 38. It is noted that the urging member 46 is not limited to the coil spring and may be the other spring (such as an air spring, not illustrated).

Furthermore, the urging member 46 is locked to a force receiving section 56 that is fixedly formed as a separate member from the valve body 52 in a middle portion in the axial direction of the valve body 52, which indicates a portion other than an end portion (i.e., the urging member 46 is left in a state of abutting on but not being coupled to the force receiving section 56), and configured to urge the valve body 52 in the direction of the valve seat 51 by directly applying the urging force to the force receiving section 56. As a modification, the force receiving section 56 may be formed integrally with the valve body 52.

By way of example, the force receiving section 56 is configured as a planar plate-like annular member using a non-magnetic member (such as a stainless alloy or a resin material) as illustrated in FIGS. 4A and 4B (where FIG. 4A is a side view and FIG. 4B is a front cross-sectional view), and provided in the needle 42 (i.e., in the spring chamber 42c). More specifically, a second surface 56b axially opposite to a first surface 56a abutting on the urging member 46, of the force receiving section 56 is provided locked to an inner surface of the bottom portion 42b of the needle 42 (i.e., the second surface 56b left in the state of abutting on but not being coupled to the inner surface of the bottom portion 42b). With the configurations, when the fixed iron core 38 is excited in proportion to an input signal (i.e., an energizing current to the coil 36), the force in an opposite direction to the urging force of the urging member 46 (thrust generated in response to the excited state) can be applied to the force receiving section 56. Therefore, the relief pressure can be variably controlled to a desired set value with respect to the set value (initial set value) of the relief pressure set by the urging member 46 (as well as the pressure regulation screw 48) by controlling (exercising proportional control over) the excited state of the fixed iron core 38 and changing the thrust of the needle 42.

In this way, the urging member 46 is abutted on (locked to) one surface of the force receiving section 56 fixed to the central portion of the valve body 52 so that the urging force can be applied to the force receiving section 56, and the needle 42 of the proportional solenoid driving section 30 is abutted on (locked to) the other surface of the force receiving section 56 so that the thrust acts on the force receiving section 56 in the opposite direction. With the configurations, it is possible to prevent the direction of action in which the needle 42 of the proportional solenoid driving section 30 applies the thrust to the valve body 52 from being deviated (tilted) from the axis line at the extremely small angle. Therefore, it is possible to suppress occurrence of the vibration resulting from the deviated (tilted) state and generated during operation.

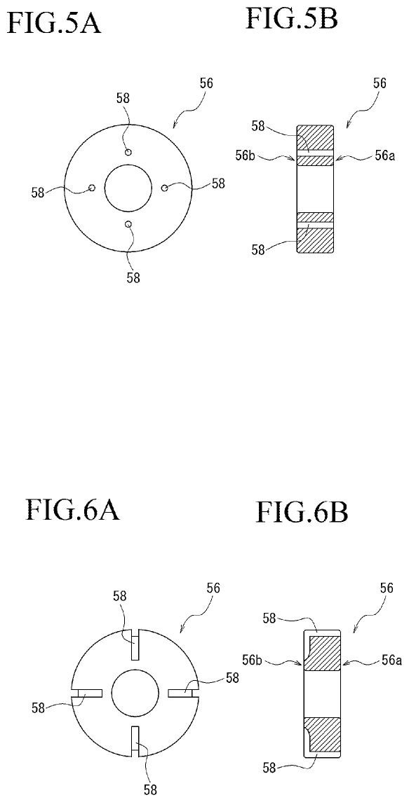

Moreover, as a modification of the force receiving section 56, the force receiving section 56 may have a flow path 58 that communicates the first surface 56a to which the urging member 46 is locked with the second surface 56b that is the axially opposite surface to the first surface 56a. Specifically, the flow path 58 may be formed into a through-hole shape as illustrated in FIGS. 5A and 5B (where FIG. 5A is a side view and FIG. 5B is a front cross-sectional view), or may be formed into a groove shape as illustrated in FIGS. 6A and 6B (where FIG. 6A is a side view and FIG. 6B is a front cross-sectional view). With these configurations, the following problem can be solved. Specifically, when the proportional solenoid driving section 30 is excited and the needle 42 moves in the direction in which the needle 42 is attracted by the fixed iron core 38 (38A), the pressure of the fluid temporarily rises in the needle 42 (in the spring chamber 42c). This results in an imbalance between the set pressure for opening the valve body 52 and the fluid pressure acting on the valve body 52, which may cause the generation of the vibration. To address the problem, the force receiving section 56 according to the modification can suppress the temporary rise in the fluid pressure in the needle 42 (in the spring chamber 42c) when the needle 42 moves. That is, it is possible to prevent generation of a pressure difference between an interior of the needle 42 (interior of the spring chamber 42c) and an exterior of the needle 42 (interior of the communication chamber 54), so that it is possible to prevent the generation of the vibration resulting from the pressure difference.

Furthermore, the relief valve 1 according to the present embodiment is configured such that no member that abuts on the valve body 52 is provided at a position between the needle 42 and the valve seat 51 in a region closer to the valve seat 51 than the force receiving section 56. This enables a degree of freedom of movement of the valve body 52 to enhance when the valve body 52 receives the pressure from the fluid in the first flow path 60. Therefore, it is possible to align an axis of the valve body 52 (particularly, a tip end portion of the valve body 52) with an axis of the valve seat 51 (opening portion), and consequently possible to further improve an effect of preventing the generation of the vibration in the valve body 52. Needless to say, it is possible to obtain an effect of reducing a manufacturing cost in proportion to a reduction in the number of components.

Alternatively, as a modification, the relief valve 1 may further include a guide member (not illustrated) that slidably supports the valve body 52 in an axially movable manner at the position between the needle 42 and the valve seat 51 in the region closer to the valve seat 51 than the force receiving section 56. This enables further improvement in straight-running stability of the valve body 52 while preventing the occurrence of the vibration in the valve body 52.

Moreover, as characteristic configurations of the relief valve 1 according to the present embodiment, the stator 38B is formed into a shape that extends to a region opposed to the valve body 52 and a shape integral with the body 40 (integral structure processed from one member) provided with the first flow path 60 in which the fluid applying the pressure to the valve body 52 flows, and has the valve seat 51 provided therein. This makes it possible to reduce an overall size of the relief valve 1, i.e., achieve the miniaturization of the relief valve 1. It is also possible to reduce the manufacturing cost by reducing the number of components. It is noted that the valve seat 51 may be configured either integrally with or separately from the body 40.

As described so far, the relief valve disclosed in the present invention is capable of preventing the vibration during operation and capable of ensuring stable fluid control, i.e., accurate relief pressure regulation. It is also possible to realize miniaturization, weight reduction, and simplification of structure.

Needless to say, the present invention is not limited to the embodiment described so far and can be changed and modified in various manners without departing from the present invention. While the hydraulic circuit that drives the work device in the working vehicle has been particularly described as an example of the target into which the relief valve is incorporated, the target into which the relief valve is incorporated is not limited to this hydraulic circuit.

Furthermore, when the relief valve is configured such that the thrust of the needle in the proportional solenoid driving section can be generated up to nearly the same value as that of the urging force of the urging member in the opposite direction, the relief valve can be also used as an unloading valve.

What is claimed is:

1. A relief valve for releasing a pressure by causing a valve body to separate from a valve seat when a pressure exceeding a set value is applied to the valve body, comprising
an urging member that applies an urging force to the valve body to pressure-contact the valve body with the valve seat, wherein
the urging member is locked to a force receiving section fixedly formed in a middle portion in an axial direction of the valve body either integrally with or separately from the valve body and directly applies the urging force to the force receiving section.

2. The relief valve according to claim 1, further comprising
a proportional solenoid driving section having a fixed iron core and a needle, wherein
the needle is locked to the force receiving section, and applies a force in an opposite direction to the urging force to the force receiving section when the fixed iron core is excited.

3. The relief valve according to claim 2, wherein
the needle is formed into a cylindrical shape with a bottom portion provided with an insertion hole at a center, and has entirety of or part of the urging member and the force receiving section provided therein.

4. The relief valve according to claim 2, wherein
the urging member is a coil spring, and
the force receiving section is an annular member.

5. The relief valve according to claim 2, wherein
the force receiving section has a flow path that communicates a first surface to which the urging member is locked with a second surface opposite to the first surface.

6. The relief valve according to claim 2, wherein
a member abutting on the valve body is not provided at a position between the needle closer to the valve seat than the force receiving section and the valve seat.

7. The relief valve according to claim 2, further comprising
a guide member slidably supporting the valve body in an axially movable manner at a position between the needle closer to the valve seat than the force receiving section and the valve seat.

8. The relief valve according to claim 2, wherein
the fixed iron core has a base provided at a farther position from the valve body, and a stator provided at a closer position to the valve body, and
the stator is formed into a shape that extends to a region opposed to the valve body and a shape integral with a body provided with a first flow path in which a fluid applying a pressure to the valve body flows, and has the valve seat provided therein.
